(19) United States
(12) Patent Application Publication
(10) Pub. No.: US 2025/0036951 A1
(43) Pub. Date: Jan. 30, 2025

(54) NEURAL NETWORK GENERATION METHOD

(71) Applicant: Socionext Inc., Kanagawa (JP)

(72) Inventor: Yukihiro SASAGAWA, Yokohama (JP)

(21) Appl. No.: 18/913,473

(22) Filed: Oct. 11, 2024

Related U.S. Application Data
(63) Continuation of application No. PCT/JP2022/018619, filed on Apr. 22, 2022.

(51) Int. Cl. G06N 3/08

(52) U.S. Cl. CPC G06N 3/08

(57) ABSTRACT

A neural network generation method includes: decomposing a trained teacher neural network including M layers into N subnetworks to generate a trained teacher neural network including N subnetworks; and generating a trained student neural network by (i) inputting a data set into each of the trained teacher neural network and a student neural network including N layers and (ii) training the student neural network. The generating of the trained student neural network includes: associating N teacher outputs and N student outputs in order of processing from an input layer toward an output layer; and determining weight data for each of the N layers in order of association, the N teacher outputs corresponding one to one to the N subnetworks, the N student outputs corresponding one to one to the N layers of the student neural network.

### CROSS REFERENCE TO RELATED APPLICATION

This is a continuation application of PCT Patent Application No. PCT/JP2022/018619 filed on Apr. 22, 2022, designating the United States of America. The entire disclosure of the above-identified application, including the specification, drawings and claims is incorporated herein by reference in its entirety.

### FIELD

The present disclosure relates to a neural network generation method for generating a trained student neural network.

### BACKGROUND

Conventional methods for training a student neural network based on a trained teacher neural network to generate a trained student neural network are known.

Non Patent Literature (NPL) 1 discloses a method for improving the efficiency of search of a network architecture by structuring a teacher neural network in block units and searching for a loss between the teacher neural network and a plurality of candidate student neural networks. This method utilizes knowledge distillation to mimic a student neural network.

### CITATION LIST

### Non Patent Literature

NPL 1: Blockwisely Supervised Neural Architecture Search with Knowledge Distillation (by Changlin Li+), ArXiv, 2019

### SUMMARY

### Technical Problem

In general, teacher neural networks are often more complex models than student neural networks. In such cases, the mimic level of the student neural network can be increased by increasing the complexity of the student neural network, but there are instances where it is difficult to increase the complexity due to the restrictions of the student neural network.

In view of the above, the present disclosure provides a neural network generation method which enables simply generating a trained student neural network.

### Solution to Problem

In order to achieve the above-described object, a neural network generation method according to one aspect of the present disclosure includes: preparing a trained teacher neural network including M layers and a student neural network including N layers, M being an integer greater than or equal to three, N being an integer greater than or equal to two and less than M; decomposing the trained teacher neural network into N subnetworks; and generating a trained student neural network by (i) inputting a data set into each of the trained teacher neural network decomposed into the N subnetworks and the student neural network and (ii) training the student neural network. In the neural network generation method, the generating of the trained student neural network includes: associating N teacher outputs and N student outputs in order of processing from an input layer toward an output layer; and determining weight data for each of the N layers of the student neural network in order of association, the N teacher outputs corresponding one to one to the N subnetworks, the N student outputs corresponding one to one to the N layers of the student neural network.

In order to achieve the above-described object, a neural network generation method according to another aspect of the present disclosure includes: preparing a trained teacher neural network including M layers and a student neural network including N layers, M being an integer greater than or equal to three, N being an integer greater than or equal to two and less than M; decomposing the trained teacher neural network into N subnetworks; and generating a trained student neural network by: inputting a data set into each of the trained teacher neural network decomposed into the N subnetworks and the student neural network; and training the student neural network. In the neural network generation method, in the decomposing of the trained teacher neural network, a plurality of grouping patterns are used for changing a decomposition position at which the trained teacher neural network is decomposed, and the generating of the trained student neural network includes: (i) associating N teacher outputs and N student outputs in order of processing from an input layer toward an output layer, the N teacher outputs corresponding one to one to the N subnetworks, the N student outputs corresponding one to one to the N layers of the student neural network; (ii) selecting, from among a plurality of combinations of the trained teacher neural network with a plurality of grouping patterns and the student neural network, a combination of the trained teacher neural network and the student neural network with a smallest evaluation value based on respective errors between the N teacher outputs and the N student outputs associated with one another; and (iii) determining, based on the student neural network included in the combination selected, weight data for each of the N layers of the student neural network included in the combination selected.

In order to achieve the above-described object, a neural network generation method according to yet another aspect of the present disclosure includes: preparing a trained teacher neural network including M layers, and a student neural network including N layers, M being an integer greater than or equal to three, N being an integer greater than or equal to two and less than M; decomposing the trained teacher neural network to include at least a first subnetwork and a second subnetwork in order from an input side; determining weight data of a first layer by (i) inputting a data set into each of the first subnetwork and the student neural network; and (ii) training the student neural network to reduce a first error based on an error between a first teacher output and a first student output, the first teacher output being an output of the first subnetwork, the first student output being an output of a first layer of the student neural network; and determining weight data of a second layer by (i) inputting a data set into each of a partial neural network including the first subnetwork and the second subnetwork and the student neural network including a first layer including the weight data determined in the determining of the weight data of the first layer and a second layer located downstream of the first layer; and (ii) training the student neural network to reduce a second error based on an error between a second teacher output and a second student output, the second teacher output being an output of the second subnetwork, the second student output being an output of the second layer.

### Advantageous Effects

With the neural network generation method according to the present disclosure, it is possible to simply generate a trained student neural network.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram illustrating one example of a teacher neural network and a student neural network.

FIG. 2 is a diagram schematically illustrating a trained teacher neural network and an untrained student neural network.

FIG. 3 is a diagram illustrating the relationship between the trained teacher neural network and the student neural network.

FIG. 4A is a diagram schematically illustrating a neural network generation method according to Embodiment 1.

FIG. 4B, following FIG. 4A, is a diagram schematically illustrating the neural network generation method.

FIG. 4C, following FIG. 4B, is a diagram schematically illustrating the neural network generation method.

FIG. 5 is a flowchart illustrating the neural network generation method according to Embodiment 1.

FIG. 6 is a diagram illustrating examples in which an error between a teacher output and a student output is multiplied by a coefficient.

FIG. 7 is a flowchart illustrating a method of deriving a coefficient by which an error is to be multiplied.

FIG. 8 is a diagram illustrating an example of the method of deriving a coefficient by which an error is to be multiplied.

FIG. 9 is a diagram illustrating an example of resizing a feature map.

FIG. 10 is a diagram illustrating another example of resizing a feature map.

FIG. 11 is a diagram schematically illustrating a neural network generation method according to Embodiment 2.

FIG. 12 is a flowchart illustrating the neural network generation method according to Embodiment 2.

FIG. 13 is a diagram illustrating an evaluation value based on errors between the teacher outputs and the student outputs.

FIG. 14 is a flowchart illustrating a method of deriving a coefficient by which an error is to be multiplied.

FIG. 15 is a diagram illustrating an example of the method of deriving a coefficient by which an error is to be multiplied.

### DESCRIPTION OF EMBODIMENTS

The following describes in detail embodiments according to the present disclosure, with reference to the drawings. It should be noted that each of the exemplary embodiments described below shows one specific example of the present disclosure. The numerical values, shapes, materials, standards, structural components, the arrangement and connection of the structural components, steps, the processing order of the steps etc. described in the following embodiments are mere examples, and therefore do not limit the scope of the present disclosure. In addition, among the structural components in the following embodiments, structural components not recited in any one of the independent claims which indicates the broadest concept of the present disclosure are described as arbitrary structural elements. In addition, the respective diagrams are not necessarily precise illustrations. In each of the diagrams, substantially the same structural components are assigned with the same reference signs, and there are instances where redundant descriptions will be omitted or simplified.

### [Fundamental Configuration of Neural Network]

The following describes the fundamental configurations of a teacher neural network and a student neural network.

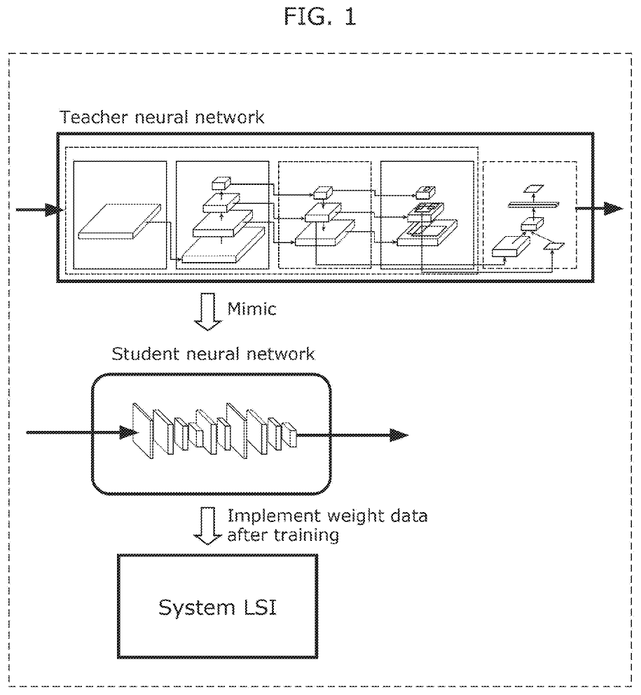

FIG. 1 is a diagram illustrating one example of a teacher neural network and a student neural network.

Each of the neural networks illustrated in FIG. 1 has a multilayer structure, and includes an input layer, a plurality of intermediate layers, and an output layer. Each of the input layer, the plurality of intermediate layers, and the output layer is, for example, a convolution layer or a fully connected layer, and includes a plurality of nodes (illustration omitted) corresponding to neurons.

Since a teacher neural network includes a complex inference model, the load when using a teacher neural network is often heavy. In view of the above, a student neural network that mimics a teacher neural networks is used.

The student neural network is a simple inference model and includes fewer layers as a whole than the teacher neural network. The student neural network according to the present disclosure is a model for implementing processing comparable to the processing of the teacher neural network with fixed hardware such as a system large scale integrated circuit (LSI). A total number of layers of the student neural network is determined in advance according to the hardware configuration of the system LSI, or the like. On the other hand, the weight data of layers of the system LSI corresponding one to one to layers of the student neural network are variable, and the weight data can be implemented in the system LSI later.

In the neural network generation method of the present disclosure, a trained student neural network is generated by training a student neural network under the restriction that the total number of layers of the student neural network is determined in advance, and determining the weight data for each layer. For example, by implementing the weight data of a trained student neural network to a system LSI, it is possible to achieve processing comparable to the processing of a teacher neural network by the system LSI described above.

Here, in order to facilitate understanding of the present disclosure, each of the teacher neural network and the student neural network is described schematically as below.

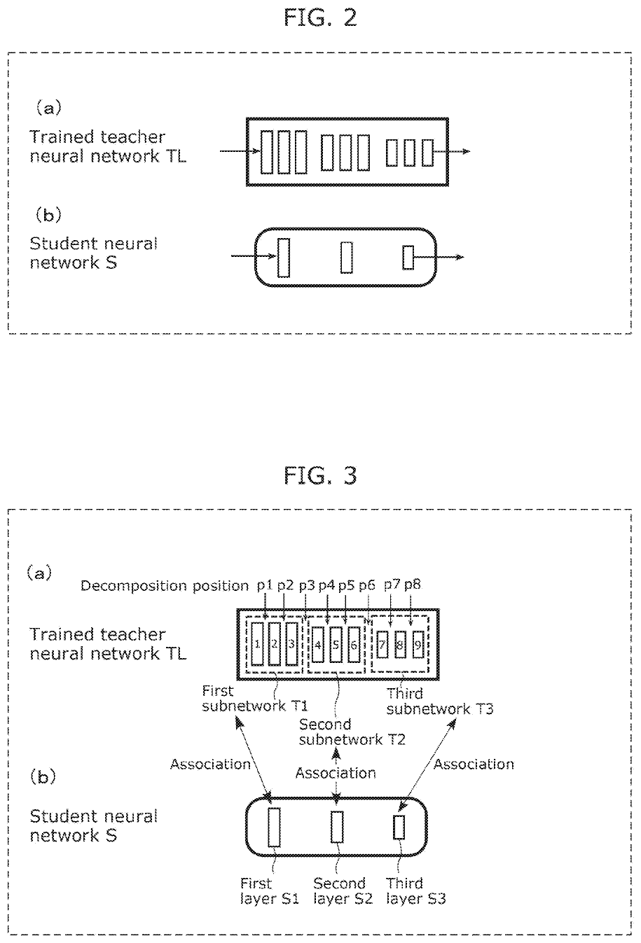

FIG. 2 is a diagram schematically illustrating trained teacher neural network TL and untrained student neural network S. FIG. 2 illustrates a schematic representation of the neural network in FIG. 1.

Trained teacher neural network TL illustrated in (a) of FIG. 2 includes M layers (M is an integer greater than or equal to three). M is a total number of layers when trained teacher neural network TL is represented by a layer structure. In this example, trained teacher neural network TL includes nine layers. For example, the first layer of the nine layers is an input layer, and the second to nine layers are intermediate layers. It should be noted that all of the nine layers may be the intermediate layers.

Untrained student neural network S illustrated in (b) of FIG. 2 includes N layers (N is an integer greater than or equal to two) which are fewer than M layers. N is a total number of layers when student neural network S is represented by a layer structure, and is determined in advance, for example, according to the hardware configuration of the system LSI, or the like. In this example, student neural network S includes three layers. For example, the first layer of the three layers is an input layer, and the second and third layers are intermediate layers. It should be noted that all of the three layers may be the intermediate layers.

The following describes embodiments in which student neural network S including three layers is trained based on trained teacher neural network TL including nine layers, and weight data is determined for each of the three layers.

### Embodiment 1

### [Overview of Neural Network Generation Method]

FIG. 3 is a diagram illustrating the relationship between trained teacher neural network TL and student neural network S.

In FIG. 3, three subnetworks included in trained teacher neural network TL and three layers included in untrained student neural network S are illustrated. A subnetwork is a network that constitutes part of a neural network. A total number of subnetworks is set to three in order to match the total number of layers of student neural network S. It should be noted that the grouping of the three subnetworks illustrated in the diagram is merely one example.

The three subnetworks here are respectively referred to as first subnetwork T1, second subnetwork T2, and third subnetwork T3 in order of processing from the input layer to the output layer. In addition, the three layers included in student neural network S are respectively referred to as first layer S1, second layer S2, and third layer S3 in order of processing from the input layer to the output layer. In this example, first subnetwork T1, second subnetwork T2, and third subnetwork T3 are associated with first layer S1, second layer S2, and third layer S3 in order of arrangement from the input layer to the output layer.

For example, a total number of selections for grouping when generating three subnetworks from a neural network including nine layers is the same as a total number of selections when selecting two decomposition positions from eight decomposition positions p1 to p8 located between the respective layers of the nine layers. Accordingly, a total number of all grouping patterns when generating three subnetworks is 28 (₈C₂=28).

In Embodiment 1, instead of searching for all 28 grouping patterns, some of the 28 patterns are searched for, to determine the weight data for the three layers of student neural network S.

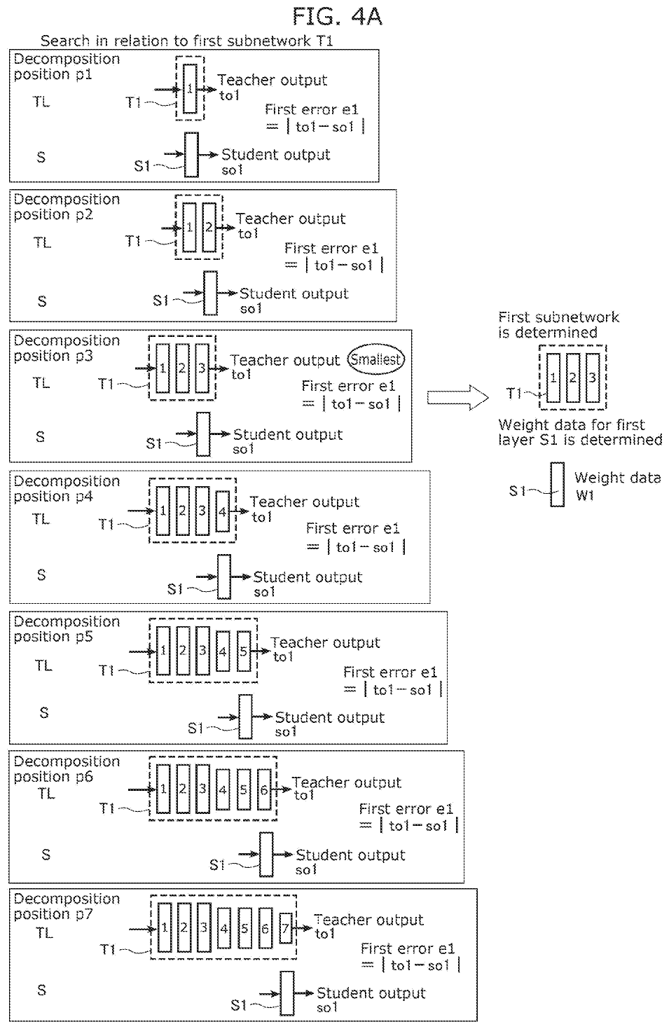

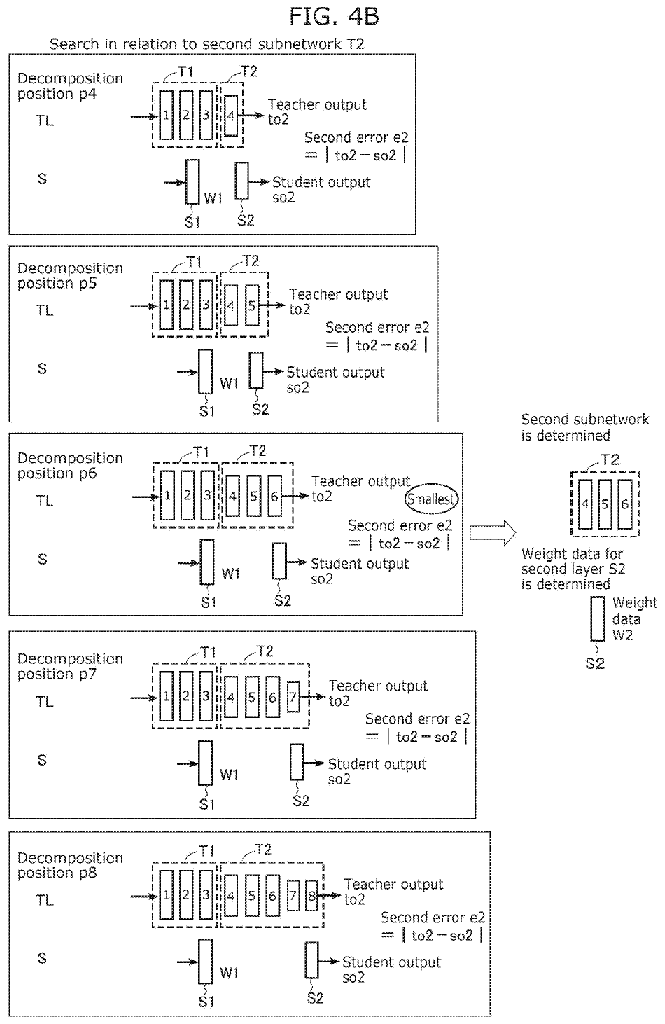

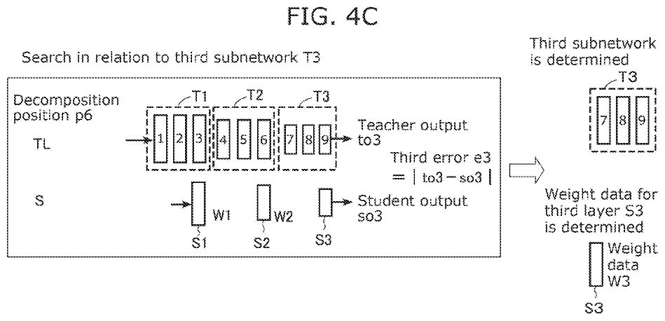

FIG. 4A, FIG. 4B, and FIG. 4C are diagrams schematically illustrating the neural network generation method according to Embodiment 1. FIG. 4A illustrates the search in relation to first subnetwork T1, FIG. 4B illustrates the search in relation to second subnetwork T2, and FIG. 4C illustrates the search in relation to third subnetwork T3.

First, as illustrated in FIG. 4A, the search in relation to first subnetwork T1 is performed. Since at least one layer is required for each of second subnetwork T2 and third subnetwork T3 in the downstream of first subnetwork T1, first subnetwork T1 is formed with less than or equal to seven layers which is a result of subtracting two layers from nine layers. In other words, first subnetwork T1 can take seven patterns when trained teacher neural network TL is decomposed at decomposition positions p1, p2, p3, p4, p5, p6, or p7, as illustrated in FIG. 4A.

Next, a data set for training which includes input data and a label is input to each of trained teacher neural network TL and student neural network S. A total number of data set inputs may be 100 or may be 1000. Student neural network S is trained to reduce first error e1. First error e1 is based on an error between first teacher output to1 and first student output so1. First teacher output to1 is an output from first subnetwork T1. First student output so1 is an output from first layer S1 of student neural network S. Here, first error e1=(the error between the output of a single unit of first subnetwork T1 and the output of a single unit of first layer S1 of student neural network S). The above-described training is performed for each of the seven patterns, and the pattern with first error e1 having a smallest value is selected from among the seven patterns.

In this example, first error e1 has a smallest value when trained teacher neural network TL is decomposed at decomposition position p3, and first subnetwork T1 is determined to be the pattern when trained teacher neural network TL is decomposed at decomposition position p3, as illustrated in FIG. 4A. In addition, the weight data of first layer S1 of student neural network S is determined to be weight data W1 obtained as a result of the training of first subnetwork T1 and first layer S1 when trained teacher neural network TL is decomposed at decomposition position p3.

Next, as illustrated in FIG. 4B, the search in relation to second subnetwork T2 is performed. The search in relation to second subnetwork T2 is performed on the premise that first subnetwork T1 is fixed at decomposition position p3 that has been previously determined. Since at least one layer is required for third subnetwork T3 in the downstream of second subnetwork T2, second subnetwork T2 is formed with less than or equal to five layers which is a result of subtracting one layer from six layers other than first subnetwork T1. In other words, second subnetwork T2 can take five patterns when trained teacher neural network TL is decomposed at decomposition positions p4, p5, p6, p7, or p8 as illustrated in FIG. 4B.

Next, the data set is input to each of: trained teacher neural network TL including first subnetwork T1 and second subnetwork T2; and student neural network S including first layer S1 with weight data W1 determined previously and second layer S2 located downstream of first layer S1. Then, student neural network S is trained to reduce second error e2. Second error e2 is based on an error between second teacher output to2 and second student output so2. Second teacher output to2 is an output from second subnetwork T2. Second student output so2 is an output from second layer S2 of student neural network S. Here, second error e2=first error e1+(the error between the output of a single unit of second subnetwork T2 and the output of a single unit of second layer S2 of student neural network S). The above-described training is performed for each of the five patterns, and the pattern with second error e2 having a smallest value is selected from among the five patterns.

In this example, second error e2 has a smallest value when trained teacher neural network TL is decomposed at decomposition position p6, and second subnetwork T2 is determined to be the pattern when trained teacher neural network TL is decomposed at decomposition position p6, as illustrated in FIG. 4B. In addition, the weight data of second layer S2 of student neural network S is determined to be weight data W2 obtained as a result of the training of (i) first subnetwork T1 when trained teacher neural network TL is decomposed at decomposition position p3 and second subnetwork T2 when trained teacher neural network TL is decomposed at decomposition position p6 and (ii) first layer S1 and second layer S2.

Next, as illustrated in FIG. 4C, the search in relation to third subnetwork T3 is performed. The search in relation to third subnetwork T3 is performed on the premise that first subnetwork T1 is fixed at decomposition position p3 that has been previously determined and second subnetwork T2 is fixed at decomposition position p6 that has been previously determined. Third subnetwork T3 is formed with three layers other than first subnetwork T1 and second subnetwork T2. In other words, third subnetwork T3 can take a single pattern when trained teacher neural network TL is decomposed at decomposition position p6 as illustrated in FIG. 4C.

Next, the data set is input to each of: trained teacher neural network TL including first subnetwork T1, second subnetwork T2, and third subnetwork T3; and student neural network S including first layer S1 with weight data W1, second layer S2 with weight data W2, and third layer S3 located downstream of second layer S2. Then, student neural network S is trained to reduce third error e3. Third error e3 is based on the error between third teacher output to3 and third student output so3. Third teacher output to3 is the output from third subnetwork T3. Third student output so3 is the output from third layer S3 of student neural network S. Here, third error e3=second error e2+(the error between the output of a single unit of third subnetwork T3 and the output of a single unit of third layer S3 of student neural network S).

In the example illustrated in FIG. 4C, the weight data for third layer S3 of student neural network S is determined to be weight data W3 obtained as a result of the training of (i) the above-described trained teacher neural network TL and (ii) first layer S1, second layer S2, and third layer S3. With the processing as described above, weight data W1, W2, and W3 corresponding to first layer S1, second layer S2, and third layer S3, respectively, are determined, and trained student neural network SL is generated.

As described above, in Embodiment 1, three teacher outputs which are the outputs of the respective three subnetworks and three student outputs which are the outputs of the respective three layers of student neural network S are associated with one another in order of processing from the input layer toward the output layer. Then, weight data W1 to W3 of the respective three layers of student neural network S are determined in order of association, thereby generating trained student neural network SL. With the above-described method, it is possible to simply generate trained student neural network SL through the processing with a less load. For example, in the above-described example, the total number of searches is 7+5+1=13, which is less than the number of searches for all 28 patterns.

### [Flow of Neural Network Generation Method]

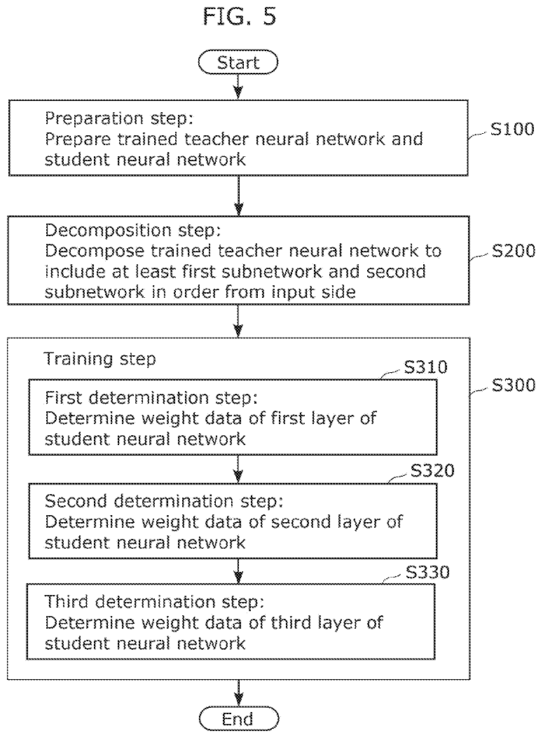

The flow of the neural network generation method will be described with reference to FIG. 5.

FIG. 5 is a flowchart illustrating the neural network generation method according to Embodiment 1.

The neural network generation method according to Embodiment 1 includes preparation step S100, decomposition step S200, and training step S300. Training step S300 includes first determination step S310, second determination step S320, and third determination step S330.

Preparation step S100 is the step of preparing trained teacher neural network TL including M layers and student neural network S including N layers. N is less than M.

Decomposition step S200 is the step of decomposing trained teacher neural network TL to include at least first subnetwork T1 and second subnetwork T2 in order from the input side. More specifically, in decomposition step S200, first subnetwork T1 and second subnetwork T2 with a plurality of grouping patterns are each generated by changing the decomposition position at which trained teacher neural network TL is decomposed. In addition, decomposition step S200 generates third subnetwork T3 which is located downstream of second subnetwork T2, by changing the decomposition position at which trained teacher neural network TL is decomposed.

It should be noted that decomposition step S200 is performed as necessary prior to each of first determination step S310, second determination step S320, and third determination step S330. For example, in this example, first subnetwork T1 is decomposed and extracted prior to first determination step S310, second subnetwork T2 is decomposed and extracted prior to second determination step S320, and third subnetwork T3 is decomposed and extracted prior to third determination step S330.

First determination step S310 is the step of determining weight data W1 of first layer S1 of student neural network S. In first determination step S310, a data set for training which includes input data and a label is input, to each of trained teacher neural network TL and student neural network S. Then, the weight data of first layer S1 is determined by training student neural network S to reduce first error e1. First error e1 is based on the error (or loss value) between first teacher output to1 that is the output of first subnetwork T1 and first student output so1 that is the output of first layer S1 of student neural network S.

More specifically, in first determination step S310, from among a plurality of combinations of first subnetwork T1 with a plurality of grouping patterns and first layer S1 of student neural network S, a combination of first subnetwork T1 and first layer S1 of student neural network S with first error e1 having a smallest value is selected. Then, based on first layer S1 of student neural network S included in the combination selected, weight data W1 of first layer S1 is determined.

Second determination step S320 is the step of determining weight data W2 of second layer S2 of student neural network S. In second determination step S320, data set is input to each of: trained teacher neural network TL including first subnetwork T1 and second subnetwork T2; and student neural network S including first layer S1 with weight data W1 determined in first determination step S310 and second layer S2 located downstream of first layer S1. Then, weight data W2 of second layer S2 is determined by training student neural network S to reduce second error e2. Second error e2 is based on the error (or loss value) between second teacher output to2 that is the output of second subnetwork T2 and second student output so2 that is the output of second layer S2 of student neural network S.

More specifically, in second determination step S320, from among the combinations of (i) a plurality of partial neural networks including first subnetwork T1 with first error e1 having a smallest value and second subnetwork T2 with a plurality of grouping patterns and (ii) first layer S1 and second layer S2 of student neural network S, a combination of a partial neural network with second error e2 having a smallest value and first layer S1 and second layer S2 of student neural network S is selected. Then, based on second layer S2 of student neural network S included in the combination selected, weight data W2 of second layer S2 is determined.

Third determination step S330 is the step of determining weight data W3 of third layer S3 of student neural network S. In third determination step S330, a data set is input to each of: trained teacher neural network TL including first subnetwork T1, second subnetwork T2, and third subnetwork T3; and student neural network S including first layer S1 with weight data W1 determined in first determination step S310, second layer S2 with weight data W2 determined in second determination step S320, and third layer S3 located downstream of second layer S2. Then, weight data W3 of third layer S3 is determined by training student neural network S to reduce third error e3. Third error e3 is based on the error (or loss value) between third teacher output to3 that is the output of third subnetwork T3 and third student output so3 that is the output of third layer S3 of student neural network S.

By performing the above-described steps S100 to S300, it is possible to simply generate trained student neural network SL through the processing with a less load.

It should be noted that, when, in decomposition step S200, trained teacher neural network TL can be decomposed to generate third subnetwork T3 with a plurality of grouping patterns, i.e., other subnetworks different from third subnetwork T3 can be further generated, third determination Step S330 may be carried out as indicated below.

In this case, in third determination step S330, from among the combinations of (i) a plurality of partial neural networks including first subnetwork T1 with first error e1 having a smallest value, second subnetwork T2 with second error e2 having a smallest value, and third subnetwork T3 with a plurality of grouping patterns and (ii) first layer S1, second layer S2, and third layer S3 of student neural network, a combination of the partial neural network with third error e3 having a smallest value and first layer S1, second layer S2, and third layer S3 of student neural network S is selected. Then, based on third layer S3 of student neural network S included in the combination selected, weight data W3 of third layer S3 is determined.

In addition, the data set used in the above-described training step S300 is, for example, the same data set, but the input data or the label need not necessarily being the same. The data set may be a super data set that includes all input data and labels, or it may be a sub data set that includes some representative input data and labels. For example, the teacher neural network may be trained by inputting teacher training data that is a data set for teacher training, and student neural network S may be trained by part of the data set of the teacher training data. In other words, the data set used in training step S300 may include a sub data set that is a portion of the teacher training data. In this case, student neural network S may further be trained using the teacher training data.

### [Variation 1 of Embodiment 1]

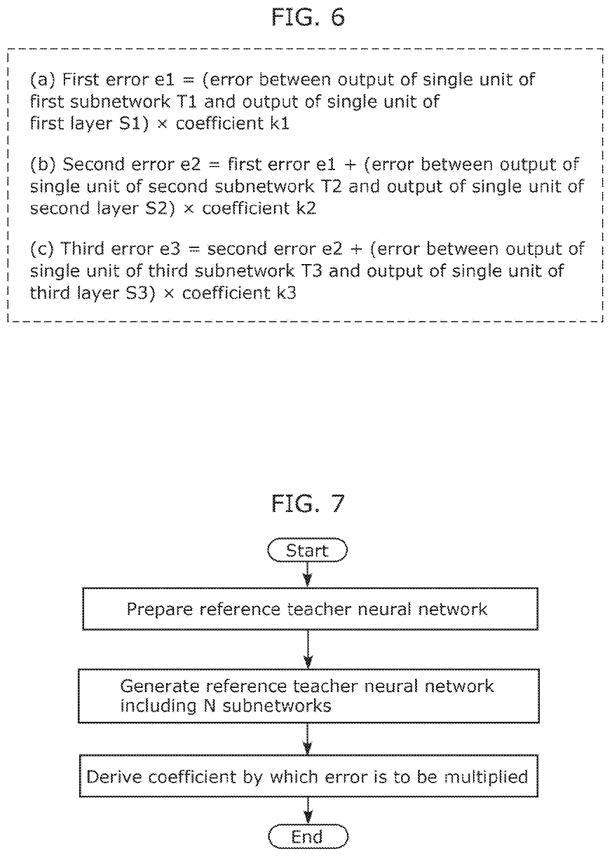

Variation 1 of Embodiment 1 will be described with reference to FIG. 6 to FIG. 8.

In Embodiment 1, an example of training student neural network S so as to reduce the error between the teacher output and the student output has been described, but the present disclosure is not limited to this example, and student neural network S can also be trained by multiplying an error by a coefficient and performing the training so as to reduce the error obtained by the multiplying. In view of the above, in Variation 1, a method of deriving a coefficient by which an error is to be multiplied.

FIG. 6 is a diagram illustrating examples in which an error between a teacher output and a student output is multiplied by a coefficient.

In (a) of FIG. 6, first error e1 that is a value obtained by multiplying the error between the output of a single unit of first subnetwork T1 and the output of a single unit of first layer S1 by coefficient k1. In (b) of FIG. 6, second error e2 that is a value obtained by multiplying the error between the output of a single unit of second subnetwork T2 and the output of a single unit of second layer S2 by coefficient k2, and adding up a result of the multiplication to first error e1. In (c) of FIG. 6, third error e3 that is a value obtained by multiplying the error between the output of a single unit of third subnetwork T3 and the output of a single unit of third layer S3 by coefficient k3, and adding up a result of the multiplication to second error e2.

Each error may be a loss value that is the difference between the teacher output and the student output. Each of coefficients k1, k2, and k3 is a value indicating the importance of the error in each output, and it is indicated that the larger the value of the coefficient is, the more important the error in its output is.

In this example, each coefficient is derived based on the behavioral sensitivity of a target neural network. It should be noted that each coefficient is derived in advance for each error in the preparation stage prior to performing the flow of the neural network generation method illustrated in FIG. 5.

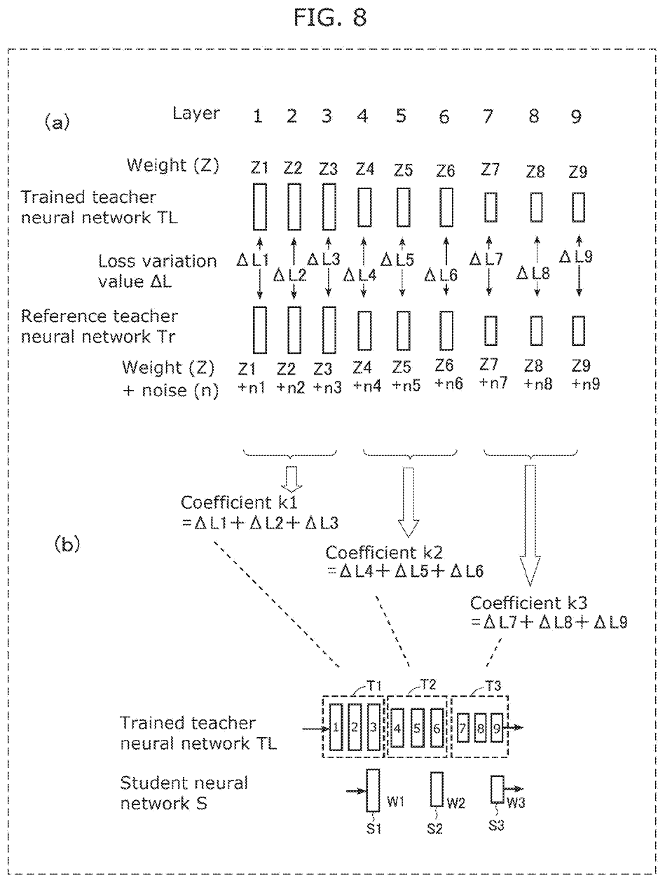

FIG. 7 is a flowchart illustrating the method of deriving a coefficient by which an error is to be multiplied. FIG. 8 is a diagram illustrating an example of the method of deriving a coefficient by which an error is to be multiplied.

As illustrated in FIG. 7, the method of deriving a coefficient includes the steps of: preparing reference teacher neural network Tr; generating reference teacher neural network Tr including N subnetworks; and deriving a coefficient by which an error is to be multiplied.

In the step of preparing reference teacher neural network Tr, reference teacher neural network Tr having noise-added weight data is prepared. The noise-added weight data is obtained by adding noise to the weight data corresponding to the respective layers of trained teacher neural network TL.

In the step of generating reference teacher neural network Tr including N subnetworks, reference teacher neural network Tr is decomposed into N subnetworks, thereby generating reference teacher neural network Tr having N subnetworks.

In the step of deriving a coefficient, a data set is provided, as an input, to each of trained teacher neural network TL and reference teacher neural network Tr, a total value of the variation of a loss value due to noise for each of N subnetworks is calculated using the loss value between the outputs of layers of trained teacher neural network TL and reference teacher neural network Tr corresponding to each other, and a coefficient is set based on the magnitude relationship of the calculated total value.

More specifically, in the step of deriving a coefficient, as illustrated in (a) of FIG. 8, loss variation value ΔL of each layer of trained teacher neural network TL is measured using (Z+n) as a comparison target. (Z+n) is obtained by adding noise (n) to weight (Z) of each layer of trained teacher neural network TL. Then, the coefficient is set to a larger value from the subnetwork corresponding to the one with the larger value of loss variation value ΔL. For example, as illustrated in (b) of FIG. 8, loss variation values ΔL of the respective layers in the respective subnetworks T1, T2, and T3 are added up to derive the respective coefficients k1, k2, and k3. By multiplying an error by the coefficient obtained in this way, it is possible to evaluate the error (or loss) between the teacher output and the student output according to the behavioral sensitivity of the neural network.

### [Variation 2 of Embodiment 1]

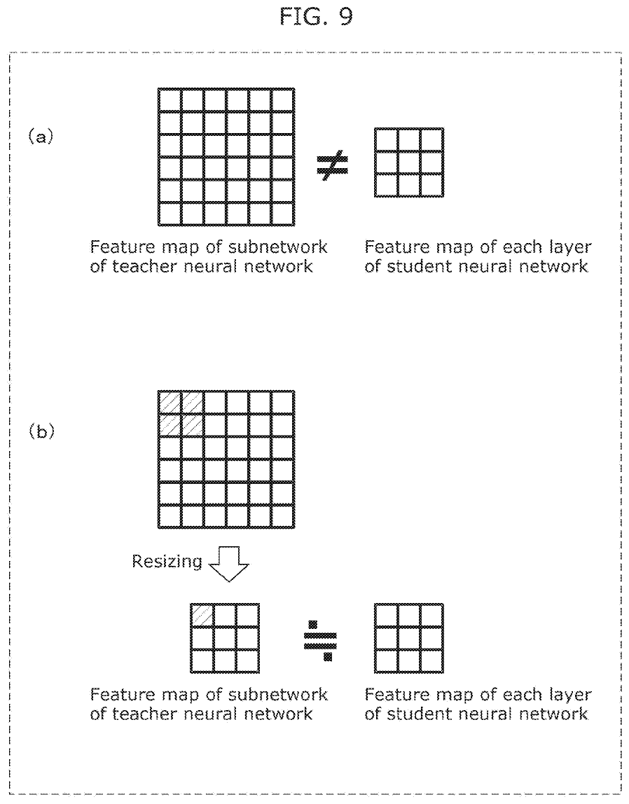

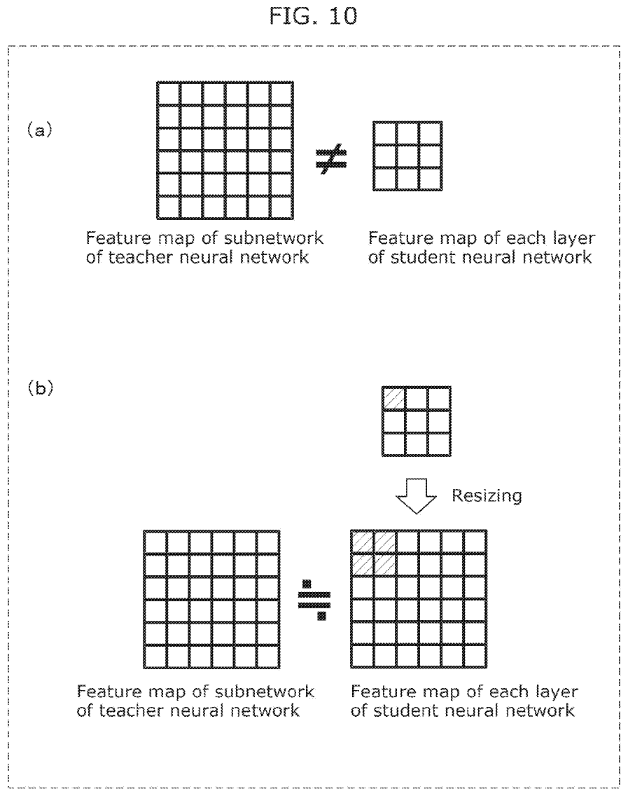

Variation 2 of Embodiment 1 will be described with reference to FIG. 9 and FIG. 10.

In Embodiment 1, an example of obtaining an error by simply comparing the teacher output and the student output. However, the present disclosure is not limited to this example, and an error can also be obtained after equalizing the sizes of the feature map of each subnetwork and the feature map of each layer of the student neural network. In view of the above, in Variation 2, an example in which the feature maps are resized and equalized will be described.

FIG. 9 is a diagram illustrating an example of resizing a feature map.

FIG. 9 illustrates in (a) an example in which the feature map of the subnetwork is larger than the feature map of each layer of the student neural network. In this example, as illustrated in (b) of FIG. 9, the feature map of the subnetwork is reduced to the same size as the feature map of each layer of the student neural network. As the method of resizing, for example, the method same as the pooling calculation of a convolutional neural network (CNN) or a method such as the complementary kernel (Bi-Linear) performed in image resizing is used. In this manner, by performing the resizing, it is possible to accurately calculate the error between the teacher out and the student output.

FIG. 10 is a diagram illustrating another example of resizing a feature map.

FIG. 10 illustrates in (a) an example in which the feature map of the subnetwork is larger than the feature map of each layer of the student neural network. In this example, as illustrated in (b) of FIG. 10, the feature map of the student neural network is enlarged to the same size as the feature map of the subnetwork. As the method of resizing, for example, the method same as the up-sampling calculation of a convolutional neural network (CNN) or a method such as the complementary kernel (Bi-Linear) performed in image resizing is used. In this manner, by performing the resizing, it is possible to accurately calculate the error between the teacher out and the student output.

For example, in first determination step S310 illustrated in FIG. 5, a loss calculation may be carried out after converting the size of one of the feature map of first teacher output to1 or the feature map of first student output so1 to match the size of the other of the feature map of first teacher output to1 or the feature map of first student output sot, to obtain first error et. In second determination step S320, a loss calculation may be carried out after converting the size of one of the feature map of second teacher output to2 or the feature map of second student output so2 to match the size of the other of the feature map of second teacher output to2 or the feature map of second student output so2, to obtain second error e2. In third determination step S330, a loss calculation may be carried out after converting the size of one of the feature map of third teacher output to3 or the feature map of third student output so3 to match the size of the other of the feature map of third teacher output to3 or the feature map of third student output so3, to obtain third error e3.

### Embodiment 2

### [Overview of Neural Network Generation Method]

In Embodiment 2, an example of performing a full search related to first subnetwork T1, second subnetwork T2, and third subnetwork T3 will be described. It should be noted that, in order to facilitate understanding of the present disclosure, each of the teacher neural network and the student neural network is described schematically in also Embodiment 2.

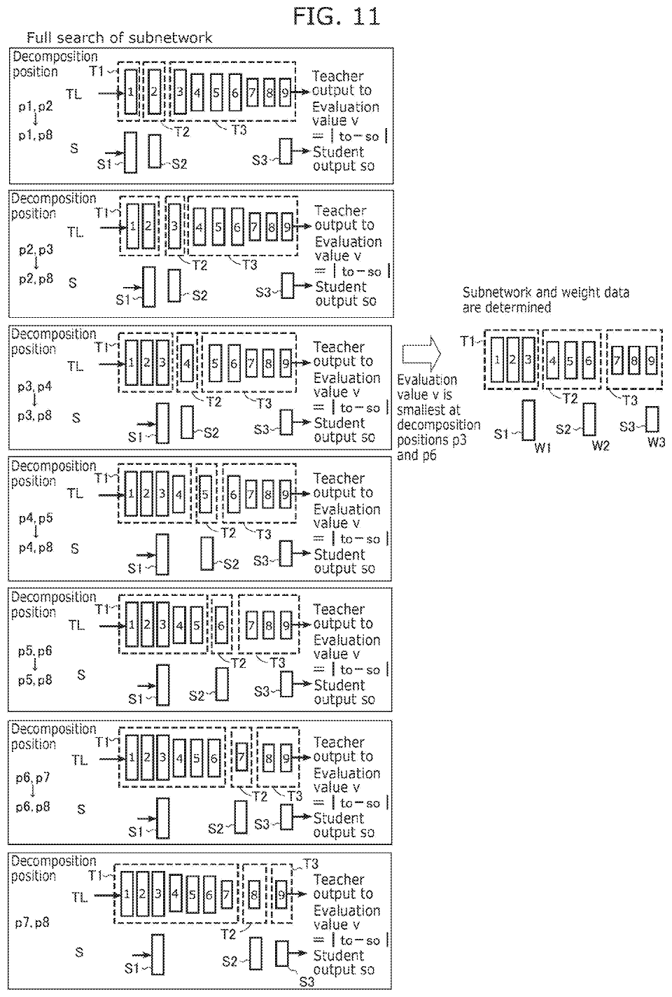

FIG. 11 is a diagram schematically illustrating the neural network generation method according to Embodiment 2.

For example, the grouping pattern for decomposing trained teacher neural network TL including M layers to generate N subnetworks is represented by (_{M-1}C_{N-1}). In this example, M=9 and N=3, and thus the grouping pattern is (₉₋₁C₃₋₁) pattern. In other words, in Embodiment 2, all 28 grouping patterns are searched to determine the weight data for the three layers of student neural network S.

In Embodiment 2, a full search related to first subnetwork T1, second subnetwork T2, and third subnetwork T3 is carried out. First subnetwork T1, second subnetwork T2, and third subnetwork T3 can take 28 patterns when decomposed at decomposition positions p1, p2, p3, p4, p5, p6, p7 and p8. It should be noted that the description “decomposition positions p1, p2→p1, p8” in FIG. 11 indicates that decomposition position p1 was fixed and the other decomposition position was changed from p2 to p8, to perform the search for a total of 7 patterns. The same is true for the description of the other decomposition positions.

Next, a data set for training which includes input data and a label is input into each of trained teacher neural network TL and student neural network S. A total number of data set inputs may be 100 or may be 1000. Then, student neural network S is trained to reduce evaluation value v based on the error between teacher output which is the output of trained teacher neural network TL and student output which is the output of student neural network S. This training is performed for each of the 28 patterns, and the pattern with smallest evaluation value v is selected from among the 28 patterns.

In this example, evaluation value v is the smallest when trained teacher neural network TL is decomposed at decomposition positions p3 and p6, first subnetwork T1 is determined to be the pattern when trained teacher neural network TL is decomposed at decomposition position p3, and second subnetwork T2 and third subnetwork T3 are determined to be the patterns when trained teacher neural network TL is decomposed at decomposition position p6, as illustrated in FIG. 11. In addition, the weight data for each layer of student neural network S is the weight data when trained teacher neural network TL is decomposed at decomposition positions p3 and p6. The weight data for first layer S1 is determined to be W1, the weight data for second layer S2 is determined to be W2, and the weight data for third layer S3 is determined to be W3.

In Embodiment 2, a full search is performed for three subnetworks and weight data W1 to W3 of the respective three layers of student neural network S are determined, thereby generating trained student neural network SL. According to this method, it is possible to accurately and simply generate trained student neural network SL.

### [Flow of Neural Network Generation Method]

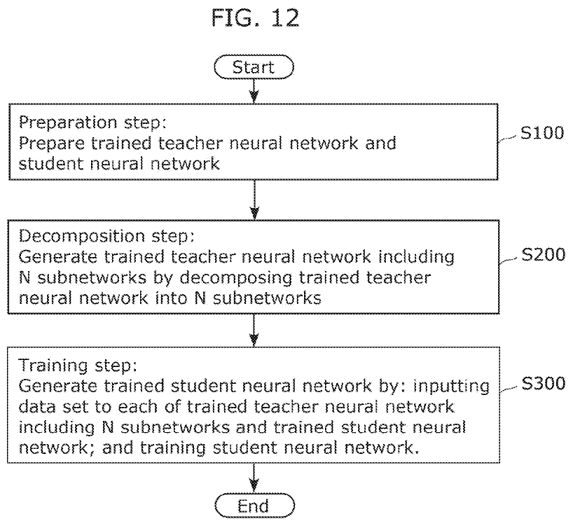

The flow of the neural network generation method will be described with reference to FIG. 12.

FIG. 12 is a flowchart illustrating the neural network generation method according to Embodiment 2.

The neural network generation method according to Embodiment 2 includes preparation step S100, decomposition step S200, and training step S300.

Preparation step S100 is the step of preparing trained teacher neural network TL including M layers and student neural network S including N layers. N is less than M.

Decomposition step S200 is the step of generating trained teacher neural network TL including N subnetworks by decomposing trained teacher neural network TL into N subnetworks. In decomposition step S200, trained teacher neural network TL having a plurality of grouping patterns is generated by changing the decomposition position at which trained teacher neural network TL is decomposed.

Training step S300 is the step of generating trained student neural network SL by: inputting a data set to each of trained teacher neural network TL including N subnetworks and student neural network S; and training student neural network S.

More specifically, in training step S300, first, N teacher outputs which are the outputs of the respective N subnetworks and N student outputs which are the outputs of the respective N layers of student neural network S are associated with one another in order of processing from the input layer toward the output layer. Next, from among a plurality of combinations of trained teacher neural network TL with a plurality of grouping patterns and student neural network S, a combination of trained teacher neural network TL and student neural network S with smallest evaluation value v based on the error between the teacher output and the student output associate with each other is selected. Then, trained student neural network SL is generated by determining the weight data for each of the N layers of student neural network S based on student neural network S included in the combination selected.

By performing these steps S100 to S300, it is possible to accurately and simply generate trained student neural network SL.

### [Variation 1 of Embodiment 2]

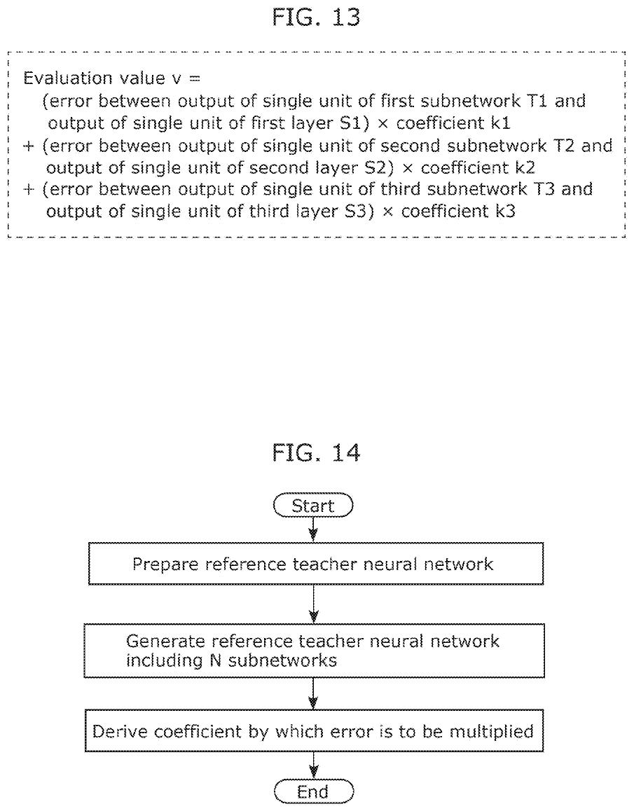

Variation 1 of Embodiment 2 will be described with reference to FIG. 13 to FIG. 15.

In Embodiment 2, an example in which student neural network S is trained to reduce evaluation value v has been described, but the present disclosure is not limited to this example, and student neural network S can also be trained to reduce evaluation value v after an error is multiplied by a coefficient. Therefore, in Variation 1, the method of deriving evaluation value v will be explained.

FIG. 13 is a diagram illustrating an evaluation value based on errors between the teacher outputs and the student outputs.

FIG. 13 indicates evaluation value v obtained by: multiplying the error between the output of a single unit of first subnetwork T1 and the output of a single unit of first layer S1 by coefficient k1; multiplying the error between the output of a single unit of second subnetwork T2 and the output of a single unit of second layer S2 by coefficient k2; multiplying the error between the output of a single unit of third subnetwork T3 and the output of a single unit of third layer S3 by coefficient k3; and adding up the results of these multiplication. In other words, evaluation value v is a sum of products of N errors which are the errors between N teacher outputs and N student outputs and the coefficients corresponding to the respective N errors.

Each error may be a loss value that is the difference between the teacher out and the student output. Each of coefficients k1, k2, and k3 is a value indicating the importance of the error in each output, and it is indicated that the larger the value of the coefficient, the more important the error in its output.

In this example as well, each coefficient is derived based on the behavioral sensitivity of a target neural network. Each coefficient is derived in advance for each error in the preparation stage prior to performing the flow of the neural network generation method illustrated in FIG. 12.

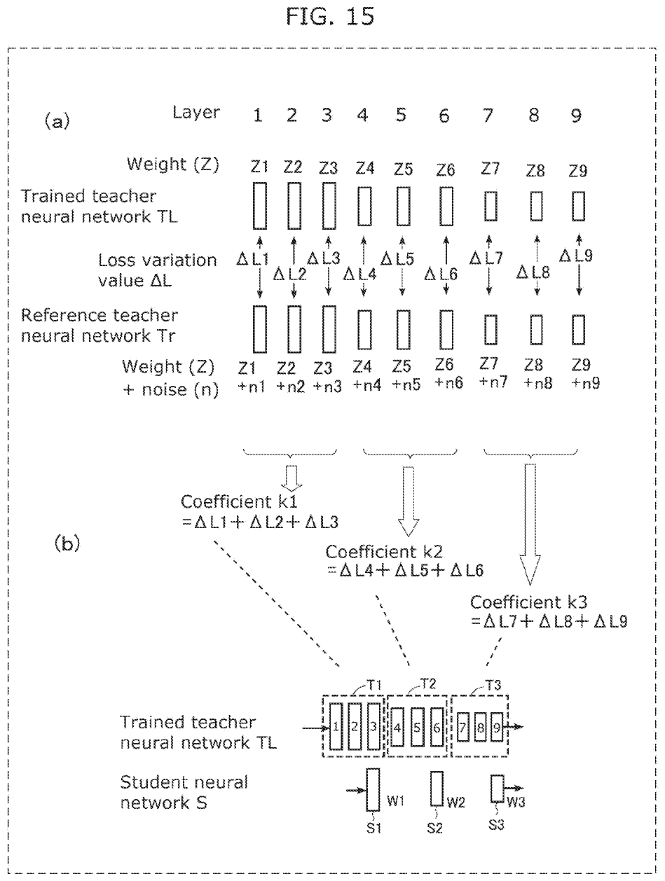

FIG. 14 is a flowchart illustrating a method of deriving a coefficient by which an error is to be multiplied. FIG. 15 is a diagram illustrating an example of the method of deriving a coefficient by which an error is to be multiplied.

As illustrated in FIG. 14, the method of deriving a coefficient includes the steps of: preparing reference teacher neural network Tr; generating reference teacher neural network Tr including N subnetworks; and deriving a coefficient by which an error is to be multiplied.

In the step of preparing reference teacher neural network Tr, reference teacher neural network Tr having noise-added weight data is prepared. The noise-added weight data is obtained by adding noise to the weight data corresponding to the respective layers of trained teacher neural network TL.

In the step of generating reference teacher neural network Tr including N subnetworks, reference teacher neural network Tr is decomposed into N subnetworks, thereby generating reference teacher neural network Tr having the N subnetworks.

In the step of deriving a coefficient, a data set is input into each of trained teacher neural network TL and reference teacher neural network Tr, a total value of the variation due to noise in the loss values for each of N subnetworks is calculated using the loss values between the outputs of each corresponding layer of trained teacher neural network TL and reference teacher neural network Tr, and a coefficient is set based on the magnitude relationship of the total value.

More specifically, in the step of deriving a coefficient, as illustrated in (a) of FIG. 15, loss variation value ΔL of each layer of trained teacher neural network TL is measured, using (Z+n) that is obtained by adding noise (n) to weight (Z) of each of the layers of trained teacher neural network TL, as a comparison target. Then, the coefficient is set to a larger value from the subnetwork corresponding to the one with the larger value of loss variation value Δ L. For example, as illustrated in (b) of FIG. 15, loss variation values ΔL of the respective layers in the respective subnetworks are added up to derive the respective coefficients k1, k2, and k3. By multiplying an error by the coefficients obtained in this way, it is possible to obtain evaluation value v based on the error between the teacher output and the student output according to the behavioral sensitivity of the neural network.

It should be noted that, in the above description, an example in which evaluation value v is obtained by simply comparing the teacher output and the student output. However, the present disclosure is not limited to this example, and evaluation value v can also be obtained after equalizing the sizes of the feature map of each subnetwork and the feature map of each layer of the student neural network. The method of resizing the feature maps to equalize the size is the same as the method of resizing described in Variation 2 of Embodiment 1.

### Conclusion

A neural network generation method according to one aspect of the present disclosure includes preparing trained teacher neural network TL including M layers and student neural network S including N layers, M being an integer greater than or equal to three, N being an integer greater than or equal to two and less than M; decomposing trained teacher neural network TL into N subnetworks; and generating trained student neural network SL by (i) inputting a data set into each of trained teacher neural network TL decomposed into the N subnetworks and student neural network S and (ii) training student neural network S. In the neural network generation method, the generating of trained student neural network SL includes: associating N teacher outputs and N student outputs in order of processing from an input layer toward an output layer; and determining weight data for each of the N layers of student neural network S in order of association, the N teacher outputs corresponding one to one to the N subnetworks, the N student outputs corresponding one to one to the N layers of student neural network S.

In this manner, by determining the weight data for each of N layers of student neural network S in order of processing from the input layer to the output layer, it is possible to simply generate trained student neural network SL through the processing with a less load. For example, in general, the training is performed using a weight of each layer having a random value as an initial value, but since there is a tendency for the behavior of the output to change with respect to the input, it is considered that the efficiency of generating a trained student neural network increases when the weight on the input side is determined first, as in the present disclosure.

In addition, in the generating of trained student neural network SL, the weight data may be determined by training student neural network S to reduce respective errors between the N teacher outputs and the N student outputs.

In this manner, by training student neural network S to reduce the above-described error, it is possible to accurately obtain the weight data for each layer of student neural network S.

A neural network generation method according to another aspect of the present disclosure includes: preparing trained teacher neural network TL including M layers and student neural network S including N layers, M being an integer greater than or equal to three, N being an integer greater than or equal to two and less than M; decomposing trained teacher neural network TL into N subnetworks; and generating trained student neural network SL by: inputting a data set into each of trained teacher neural network TL decomposed into the N subnetworks and student neural network S; and training student neural network S. In the neural network generation method, in the decomposing of trained teacher neural network TL, a plurality of grouping patterns are used for changing a decomposition position at which trained teacher neural network TL is decomposed, and the generating of trained student neural network SL includes: (i) associating N teacher outputs and N student outputs in order of processing from an input layer toward an output layer, the N teacher outputs corresponding one to one to the N subnetworks, the N student outputs corresponding one to one to the N layers of student neural network S; (ii) selecting, from among a plurality of combinations of trained teacher neural network TL with a plurality of grouping patterns and student neural network S, a combination of trained teacher neural network TL and student neural network S with a smallest evaluation value based on respective errors between the N teacher outputs and the N student outputs associated with one another; and (iii) determining, based on student neural network S included in the combination selected, weight data for each of the N layers of student neural network S included in the combination selected.

In this manner, by selecting a combination with smallest evaluation value v from among a plurality of combinations, it is possible to accurately obtain the weight data for each layer of student neural network S. As a result, it is possible to accurately and simply generate trained student neural network SL.

In addition, evaluation value v may be a sum of products of N errors and coefficients corresponding one to one to the N errors, the N errors being the respective errors between the N teacher outputs and the N student outputs.

In this manner, by multiplying each of the N errors by the corresponding coefficient, it is possible to generate evaluation value v according to the importance of the error. As a result, it is possible to generate trained student neural network SL having weight data according to the evaluation value.

In addition, the neural network generation method further includes: preparing reference teacher neural network Tr having noise-added weight data obtained by adding noise to weight data corresponding one to one to layers of trained teacher neural network TL; decomposing reference teacher neural network Tr into N subnetworks; and deriving the coefficients corresponding one to one to the N errors, based on trained teacher neural network TL and reference teacher neural network Tr. In the neural network generation method, the deriving may include: inputting the data set into each of trained teacher neural network TL and reference teacher neural network Tr; and calculating, using a loss value, a total value of variation of the loss value due to the noise for each of the N subnetworks, to derive the coefficient based on a magnitude relationship of the total value, the loss value being a loss value between outputs of layers of trained teacher neural network TL and reference teacher neural network Tr corresponding to each other.

In this manner, it is possible to obtain evaluation value v of the teacher output and the student output according to the behavioral sensitivity of the neural network. As a result, it is possible to accurately obtain weight data for each layer of student neural network S.

In addition, in the generating of trained student neural network SL, the respective errors may be each calculated by performing loss calculation after converting a size of one of a feature map of the teacher output or a feature map of the student output to match a size of an other of the feature map of the teacher output or the feature map of the student output.

In this manner, by matching the size of the feature maps, it is possible to accurately obtain the error between the teacher output and the student output. As a result, it is possible to accurately obtain weight data for each layer of student neural network S.

In addition, the teacher neural network may be trained using teacher training data, and the data set may include a portion of the teacher training data.

In this manner, it is possible to simply generate trained student neural network SL in a short amount of time.

In addition, the neural network generation method may further include training student neural network S using the teacher training data.

In this manner, it is possible to increase the reliability of trained student neural network SL.

A neural network generation method according to yet another aspect of the present disclosure includes: preparing trained teacher neural network TL including M layers, and student neural network S including N layers, M being an integer greater than or equal to three, N being an integer greater than or equal to two and less than M; decomposing trained teacher neural network TL to include at least first subnetwork T1 and second subnetwork T2 in order from an input side; determining weight data W1 of first layer S1 by (i) inputting a data set into each of first subnetwork T1 and student neural network S; and (ii) training student neural network S to reduce first error e1 based on an error between first teacher output to1 and first student output sot, first teacher output to1 being an output of first subnetwork T1, first student output so1 being an output of first layer S1 of student neural network S; and determining weight data W2 of second layer S2 by (i) inputting a data set into each of a partial neural network including first subnetwork T1 and second subnetwork T2 and student neural network S including first layer S1 including weight data W1 determined in the determining of weight data W1 of first layer S1 and second layer S2 located downstream of first layer S1; and (ii) training student neural network S to reduce second error e2 based on an error between second teacher output to2 and second student output so2, second teacher output to2 being an output of second subnetwork T2, second student output so2 being an output of second layer S2.

In this manner, by determining the weight data for each of N layers of student neural network S in order from the input side, it is possible to simply generate trained student neural network SL through the processing with a less load.

In addition, in the decomposing of trained teacher neural network TL, a decomposition position at which trained teacher neural network TL is decomposed is changed to provide first subnetwork T1 and second subnetwork T2 with a plurality of grouping patterns. The determining of weight data W1 of first layer S1 includes: selecting, from among a plurality of combinations of first subnetwork T1 with a plurality of grouping patterns and first layer S1 of student neural network S, a combination of first subnetwork T1 and first layer S1 of student neural network S with first error e1 having a smallest value; and determining weight data W1 of first layer S1 based on first layer S1 of student neural network S included in the combination selected. The determining of weight data W2 of second layer S2 may include: selecting, from among combinations of (i) a plurality of partial neural networks including first subnetwork T1 with first error e1 having a smallest value and second subnetwork T2 with a plurality of grouping patterns and (ii) first layer S1 and second layer S2 of student neural network S, a combination of a partial neural network with second error e2 having a smallest value and first layer S1 and second layer S2 of student neural network S; and determining weight data W2 of second layer S2 based on second layer S2 of student neural network S included in the combination selected.

In this manner, by selecting a combination with a smallest error from among a plurality of combinations, it is possible to accurately obtain the weight data for each layer of student neural network S.

In addition, in the determining of weight data W1 of first layer S1, first error w1 may be calculated by performing loss calculation after converting a size of one of a feature map of first teacher output to1 or a feature map of first student output so1 to match a size of an other of the feature map of first teacher output to1 or the feature map of first student output so1, and in the determining of weight data W2 of second layer S2, second error e2 may be calculated by performing loss calculation after converting a size of one of a feature map of second teacher output to2 or a feature map of second student output so2 to match a size of an other of the feature map of second teacher output to2 or the feature map of second student output so2.

In this manner, by matching the size of the feature maps, it is possible to accurately obtain the error between the teacher output and the student output. As a result, it is possible to accurately obtain weight data for each layer of student neural network S.

In addition, in the decomposing of trained teacher neural network TL, the decomposing is performed to further include third subnetwork T3 located downstream of second subnetwork T2. The neural network generation method further includes: determining weight data W3 of third layer S3 performed after the determining of weight data W2 of second layer S2, third layer S3 being located downstream of second layer S2. The determining of weight data W3 of third layer S3 may include: inputting a data set into each of (i) a partial neural network including first subnetwork T1, second subnetwork T2, and third subnetwork T3 and (ii) student neural network S including first layer S1 including weight data W1 determined in the determining of weight data W1 of first layer S1, second layer S2 including weight data W2 determined in the determining of weight data W2 of second layer S2, and third layer S3; and training student neural network S to reduce third error e3 based on an error between third teacher output to3 and third student output so3, third teacher output to3 being an output of third subnetwork T3, third student output so3 being an output of third layer S3 of student neural network S.

In this manner, by determining the weight data for each of N layers of student neural network S in order from the input side, it is possible to simply generate trained student neural network SL through the processing with a less load.

In addition, in the decomposing of trained teacher neural network TL, a decomposition position at which trained teacher neural network TL is decomposed is changed to provide first subnetwork T1 and second subnetwork T2 with a plurality of grouping patterns. The determining of weight data W1 of first layer S1 includes: selecting, from among a plurality of combinations of first subnetwork T1 with a plurality of grouping patterns and first layer S1 of student neural network S, a combination of first subnetwork T1 and first layer S1 of student neural network S with first error e1 having a smallest value; and determining weight data W1 of first layer S1 based on first layer S1 of student neural network S included in the combination selected.

The determining of weight data W2 of second layer S2 includes: selecting, from among combinations of (i) a plurality of partial neural networks including first subnetwork T1 with first error e1 having a smallest value and second subnetwork T2 with a plurality of grouping patterns and (ii) first layer S1 and second layer S2 of student neural network S, a combination of a partial neural network with second error e2 having a smallest value and first layer S1 and second layer S2 of student neural network S; and determining weight data W2 of second layer S2 based on second layer S2 of student neural network S included in the combination selected. Further in the decomposing of trained teacher neural network TL, when third subnetwork T3 is provided with a plurality of grouping patterns by changing a decomposition position at which trained teacher neural network TL is decomposed, the determining of weight data W3 of third layer S3 may include: selecting, from among combinations of (i) a plurality of partial neural networks including first subnetwork T1 with first error e1 having a smallest value, second subnetwork T2 with second error e2 having a smallest value, and third subnetwork T3 with a plurality of grouping patterns and (ii) first layer S1, second layer S2, and third layer S3 of student neural network S, a combination of a partial neural network with third error e3 having a smallest value and first layer S1, a second layer, and third layer S3 of student neural network S; and determining weight data W3 of third layer S3 based on third layer S3 of student neural network S included in the combination selected.

In this manner, by selecting a combination with a smallest error from among a plurality of combinations, it is possible to accurately obtain the weight data for each layer of student neural network S.

In addition, in the determining of weight data W1 of first layer S1, first error e1 may be calculated by performing loss calculation after converting a size of one of a feature map of first teacher output to1 or feature map of first student output so1 to match a size of an other of the feature map of first teacher output to1 or the feature map of first student output so1, and in the determining of weight data W2 of second layer S2, second error e2 may be calculated by performing loss calculation after converting a size of one of a feature map of second teacher output to2 or a feature map of second student output so2 to match a size of an other of the feature map of second teacher output to2 or the feature map of second student output so2, and in the determining of weight data W3 of third layer S3, third error e3 may be calculated by performing loss calculation after converting a size of one of a feature map of third teacher output to3 or a feature map of third student output so3 to match a size of an other of the feature map of third teacher output to3 or the feature map of third student output so3.

In this manner, by matching the size of the feature maps, it is possible to accurately obtain the error between the teacher output and the student output. As a result, it is possible to accurately obtain weight data for each layer of student neural network S.

In addition, the teacher neural network may be trained using teacher training data, and the data set may include a portion of the teacher training data.

In this manner, it is possible to simply generate trained student neural network SL in a short amount of time.

In addition, the neural network generation method may further include: training student neural network S using the teacher training data.

In this manner, it is possible to increase the reliability of trained student neural network SL.

### Other Embodiments

Although the neural network generation method according to the present disclosure has been described based on the embodiments, the present disclosure is not limited to the above embodiments.

Those skilled in the art will readily appreciate that various modifications may be made in these embodiments and that other embodiments may be obtained by arbitrarily combining the elements of these embodiments without materially departing from the novel teachings and advantages of the present disclosure. Accordingly, all such modifications and other embodiments are included in the present disclosure.

In Variation 1 of Embodiment 1 and Variation 1 of Embodiment 2, examples of determining a coefficient according to the behavioral sensitivity of the neural network have been described, but the present disclosure is not limited to this method alone. For example, since the input side of a convolutional neural network is mainly for feature extraction independent of the input, the closer to the output side, the more sensitive the behavior becomes. In view of the above, the coefficients may be set such that the closer to the output side of the neural network, the larger the coefficient becomes (e.g., k1≤k2≤k3).

In addition, forms indicated below may also be included within the scope of one or more aspects of the present disclosure.

(1) The present disclosure may also be realized as a method described above. In addition, the present disclosure may be a computer program for realizing the previously illustrated methods using a computer, and may also be a digital signal including the computer program.

(2) Furthermore, the present disclosure may also be a computer system including a microprocessor and a memory, in which the memory stores the aforementioned computer program and the microprocessor operates according to the computer program.

(3) In addition, by transferring the program or the digital signal by recording onto the aforementioned recording media, or by transferring the program or digital signal via the aforementioned network and the like, execution using another independent computer system is also made possible.

(4) The above-described embodiments and the above-described variations may respectively be combined.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

The present disclosure can be widely used for neural network generation methods such as a neural network generation method that mimics a trained teacher neural network to generate a trained student neural network.

1. A neural network generation method comprising:
preparing a trained teacher neural network including M layers and a student neural network including N layers, M being an integer greater than or equal to three, N being an integer greater than or equal to two and less than M;
decomposing the trained teacher neural network into N subnetworks; and
generating a trained student neural network by (i) inputting a data set into each of the trained teacher neural network decomposed into the N subnetworks and the student neural network and (ii) training the student neural network, wherein
the generating of the trained student neural network includes: associating N teacher outputs and N student outputs in order of processing from an input layer toward an output layer; and determining weight data for each of the N layers of the student neural network in order of association, the N teacher outputs corresponding one to one to the N subnetworks, the N student outputs corresponding one to one to the N layers of the student neural network.

2. The neural network generation method according to claim 1, wherein
in the generating of the trained student neural network, the weight data is determined by training the student neural network to reduce respective errors between the N teacher outputs and the N student outputs.

3. A neural network generation method comprising:
preparing a trained teacher neural network including M layers and a student neural network including N layers, M being an integer greater than or equal to three, N being an integer greater than or equal to two and less than M;
decomposing the trained teacher neural network into N subnetworks; and
generating a trained student neural network by: inputting a data set into each of the trained teacher neural network decomposed into the N subnetworks and the student neural network; and training the student neural network, wherein
in the decomposing of the trained teacher neural network, a plurality of grouping patterns are used for changing a decomposition position at which the trained teacher neural network is decomposed, and
the generating of the trained student neural network includes:
(i) associating N teacher outputs and N student outputs in order of processing from an input layer toward an output layer, the N teacher outputs corresponding one to one to the N subnetworks, the N student outputs corresponding one to one to the N layers of the student neural network;
(ii) selecting, from among a plurality of combinations of the trained teacher neural network with a plurality of grouping patterns and the student neural network, a combination of the trained teacher neural network and the student neural network with a smallest evaluation value based on respective errors between the N teacher outputs and the N student outputs associated with one another; and
(iii) determining, based on the student neural network included in the combination selected, weight data for each of the N layers of the student neural network included in the combination selected.

4. The neural network generation method according to claim 3, wherein
the evaluation value is a sum of products of N errors and coefficients corresponding one to one to the N errors, the N errors being the respective errors between the N teacher outputs and the N student outputs.

5. The neural network generation method according to claim 4, further comprising:
preparing a reference teacher neural network having noise-added weight data obtained by adding noise to weight data corresponding one to one to layers of the trained teacher neural network;
decomposing the reference teacher neural network into N subnetworks; and
deriving the coefficients corresponding one to one to the N errors, based on the trained teacher neural network and the reference teacher neural network, wherein
the deriving includes:
inputting the data set into each of the trained teacher neural network and the reference teacher neural network; and calculating, using a loss value, a total value of variation of the loss value due to the noise for each of the N subnetworks, to derive the coefficient based on a magnitude relationship of the total value, the loss value being a loss value between outputs of layers of the trained teacher neural network and the reference teacher neural network corresponding to each other.

6. The neural network generation method according to claim 3, wherein
in the generating of the trained student neural network, the respective errors are each calculated by performing loss calculation after converting a size of one of a feature map of the teacher output or a feature map of the student output to match a size of an other of the feature map of the teacher output or the feature map of the student output.

7. The neural network generation method according to claim 3, wherein
the teacher neural network is trained using teacher training data, and
the data set includes a portion of the teacher training data.

8. The neural network generation method according to claim 7, further comprising:
training the student neural network using the teacher training data.

9. A neural network generation method comprising:
preparing a trained teacher neural network including M layers, and a student neural network including N layers, M being an integer greater than or equal to three, N being an integer greater than or equal to two and less than M;
decomposing the trained teacher neural network to include at least a first subnetwork and a second subnetwork in order from an input side;
determining weight data of a first layer by (i) inputting a data set into each of the first subnetwork and the student neural network; and (ii) training the student neural network to reduce a first error based on an error between a first teacher output and a first student output, the first teacher output being an output of the first subnetwork, the first student output being an output of a first layer of the student neural network; and
determining weight data of a second layer by (i) inputting a data set into each of a partial neural network including the first subnetwork and the second subnetwork and the student neural network including a first layer including the weight data determined in the determining of the weight data of the first layer and a second layer located downstream of the first layer; and (ii) training the student neural network to reduce a second error based on an error between a second teacher output and a second student output, the second teacher output being an output of the second subnetwork, the second student output being an output of the second layer.

10. The neural network generation method according to claim 9, wherein
in the decomposing of the trained teacher neural network, a decomposition position at which the trained teacher neural network is decomposed is changed to provide the first subnetwork and the second subnetwork with a plurality of grouping patterns,
the determining of the weight data of the first layer includes: selecting, from among a plurality of combinations of the first subnetwork with a plurality of grouping patterns and a first layer of the student neural network, a combination of the first subnetwork and a first layer of the student neural network with the first error having a smallest value; and determining the weight data of the first layer based on the first layer of the student neural network included in the combination selected, and
the determining of the weight data of the second layer includes: selecting, from among combinations of (i) a plurality of partial neural networks including the first subnetwork with the first error having a smallest value and the second subnetwork with a plurality of grouping patterns and (ii) a first layer and a second layer of the student neural network, a combination of a partial neural network with the second error having a smallest value and a first layer and a second layer of the student neural network; and determining the weight data of the second layer based on the second layer of the student neural network included in the combination selected.

11. The neural network generation method according to claim 9, wherein
in the determining of the weight data of the first layer, the first error is calculated by performing loss calculation after converting a size of one of a feature map of the first teacher output or a feature map of the first student output to match a size of an other of the feature map of the first teacher output or the feature map of the first student output, and
in the determining of the weight data of the second layer, the second error is calculated by performing loss calculation after converting a size of one of a feature map of the second teacher output or a feature map of the second student output to match a size of an other of the feature map of the second teacher output or the feature map of the second student output.

12. The neural network generation method according to claim 9, wherein
in the decomposing of the trained teacher neural network, the decomposing is performed to further include a third subnetwork located downstream of the second subnetwork,
the neural network generation method further comprises: determining weight data of a third layer performed after the determining of the weight data of the second layer, the third layer being located downstream of the second layer, and
the determining of the weight data of the third layer includes:
inputting a data set into each of (i) a partial neural network including the first subnetwork, the second subnetwork, and the third subnetwork and (ii) the student neural network including the first layer including the weight data determined in the determining of the weight data of the first layer, the second layer including the weight data determined in the determining of the weight data of the second layer, and the third layer; and training the student neural network to reduce a third error based on an error between a third teacher output and a third student output, the third teacher output being an output of the third subnetwork, the third student output being an output of a third layer of the student neural network.

13. The neural network generation method according to claim 12, wherein
in the decomposing of the trained teacher neural network, a decomposition position at which the trained teacher neural network is decomposed is changed to provide the first subnetwork and the second subnetwork with a plurality of grouping patterns,
the determining of the weight data of the first layer includes: selecting, from among a plurality of combinations of the first subnetwork with a plurality of grouping patterns and a first layer of the student neural network, a combination of the first subnetwork and a first layer of the student neural network with the first error having a smallest value; and determining the weight data of the first layer based on the first layer of the student neural network included in the combination selected,
the determining of the weight data of the second layer includes: selecting, from among combinations of (i) a plurality of partial neural networks including the first subnetwork with the first error having a smallest value and the second subnetwork with a plurality of grouping patterns and (ii) a first layer and a second layer of the student neural network, a combination of a partial neural network with the second error having a smallest value and a first layer and a second layer of the student neural network; and determining the weight data of the second layer based on the second layer of the student neural network included in the combination selected, and
further in the decomposing of the trained teacher neural network, when the third subnetwork is provided with a plurality of grouping patterns by changing a decomposition position at which the trained teacher neural network is decomposed,
the determining of the weight data of the third layer includes:
selecting, from among combinations of (i) a plurality of partial neural networks including the first subnetwork with the first error having a smallest value, the second subnetwork with the second error having a smallest value, and the third subnetwork with a plurality of grouping patterns and (ii) a first layer, a second layer, and a third layer of the student neural network, a combination of a partial neural network with the third error having a smallest value and a first layer, a second layer, and a third layer of the student neural network; and determining the weight data of the third layer based on the third layer of the student neural network included in the combination selected.

14. The neural network generation method according to claim 12, wherein
in the determining of the weight data of the first layer, the first error is calculated by performing loss calculation after converting a size of one of a feature map of the first teacher output or a feature map of the first student output to match a size of an other of the feature map of the first teacher output or the feature map of the first student output, and
in the determining of the weight data of the second layer, the second error is calculated by performing loss calculation after converting a size of one of a feature map of the second teacher output or a feature map of the second student output to match a size of an other of the feature map of the second teacher output or the feature map of the second student output, and
in the determining of the weight data of the third layer, the third error is calculated by performing loss calculation after converting a size of one of a feature map of the third teacher output or a feature map of the third student output to match a size of an other of the feature map of the third teacher output or the feature map of the third student output.

15. The neural network generation method according to claim 9, wherein
the teacher neural network is trained using teacher training data, and
the data set includes a portion of the teacher training data.

16. The neural network generation method according to claim 15, further comprising:
training the student neural network using the teacher training data.
